(19) United States
(12) Patent Application Publication
(10) Pub. No.: US 2005/0166160 A1
(43) Pub. Date: Jul. 28, 2005

(54) User interfaces which display aggregations of records that include fields whose values can be set null or empty

(75) Inventors: Dean W. Bergstrom, West Linn, OR (US); Kenneth James Park, Cathlamet, WA (US)

Correspondence Address: Robert D. Varitz;ROBERT D. VARITZ, P.C., 2007 S.E.Grant Street, Portland, OR, 97214, US

(73) Assignee: Sharp Laboratories of America, Inc.

(21) Appl. No.: 10/764,320

(22) Filed: Jan. 23, 2004

(51) Int. Cl. G06F 17/00; G06K 9/34; G06F 3/00; G06F 17/21

(52) U.S. Cl. 715/780; 707/104.1; 382/175; 715/505; 715/507; 715/529

(57) ABSTRACT

A method of providing a user interface for use with a data base, wherein the database includes plural records, each having plural data fields therein, wherein a data field contains information taken from the group of information types consisting of entered information, empty and null, wherein empty and null data fields comprise blank data fields, includes displaying a selected record according to a display protocol; determining if the display protocol requires display of a blank data field of the record, and, if so, displaying a substitute data field which is taken from the group of data fields consisting of system generated data fields and alternate data fields; wherein displaying a substitute data field includes displaying the information in the substitute data field in a enhanced manner to alert a user to the presence of the substitute information.

### FIELD OF THE INVENTION

This invention relates to data base displays, and specifically to a user interface which displays null fields in a manner to indicate that the field exists.

### BACKGROUND OF THE INVENTION

There are software applications with user interfaces that present an aggregation of the records where the presentation of each record is abbreviated to a subset of the fields in those records. A common example of this is an address book. Records may exist which omit, leave blank or otherwise contain null values for the fields contained in the subset presented in the aggregate view while storing pertinent information in other record fields. This creates a problem for the user because there is no information in the aggregate view to differentiate these records.

In the prior art, when a field is absent there are several solutions for record display:
(1) In Microsoft® Outlook®, the field is simply missing and a blank field is presented. This can be a problem when there are several entries like this then the user is presented with several identical blank entries; (2) In Palm PDA's and the Sharp Z-800, an alternate field is selected for display in the aggregate view. For example, if the name is unavailable in a phone book entry, the phone number would be displayed instead. The problem with this solution is that there can be ambiguity between whether or not the displayed information is an alternate field.

U.S. Pat. No. 5,228,100, to Takeda et al., granted Jul. 13, 1993, for Method and system for producing from document image a form display with blankfields and a program to input data to the blank fields, describes recognition of a form and distinguishing it from the text input fields of the form, the re-rendering of the form such that the text is removed from the input fields, the ability of a user to enter new text into the newly blanked out input fields.

### SUMMARY OF THE INVENTION

A method of providing a user interface for use with a data base, wherein the database includes plural records, each having plural data fields therein, wherein a data field contains information taken from the group of information types consisting of entered information, empty and null, wherein empty and null data fields comprise blank data fields, includes displaying a selected record according to a display protocol; determining if the display protocol requires display of a blank data field of the record, and, if so, displaying a substitute data field which is taken from the group of data fields consisting of system generated data fields and alternate data fields; wherein displaying a substitute data field includes displaying the information in the substitute data field in a enhanced manner to alert a user to the presence of the substitute information.

It is an object of the invention to provide an indication of the character of data in a data filed in a data base through a user interface.

Another object of the invention is to provide for display of an alternate field in place of a blank field.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts a user interface displaying data according to the method of the invention.

### DETAILED DESCRIPTION OF THE PREFERRED EMBODIMENT

This invention provides a means for presenting records with empty fields in an aggregate view by using a system generated fill in place of the fields that would normally be displayed as a blank, null or empty field. Using the method of the invention, this is no ambiguity as to whether a field is blank, or simply contains text indicating that it is empty. A data base system and user interface display incorporating the method of the invention includes a data base, having plural records therein, wherein each record contains plural data fields. A data base record includes fields which contain entered information, however, not all fields are filled, i.e., some fields may be empty in that data has never been entered into the field, or a field may be null in that the filed has been filled with a zero value or other null indicator, either of which is referred to herein as a blank field. The method of the invention is described in connection with a commonly used data base: the address book of a cellular phone or other personal communication device, however, the method of the invention is equally suited for use with any form of database operating on any form of data base manipulation system.

The method of the invention modifies the display protocol for a device using the method of the invention to provide for display of substitute information when a required data field is blank. For instance, assume that the display protocol for a particular device requires that an address book be displayed using the given names of the individuals listed in the address book. Records may exist in the data base which do not contain entered information for an addressee's given name, but may include entered information for the addressee's sir name and/or phone number. Known data base systems will, given the above-described scenario, display a blank screen because the display protocol requires display of the given name, and does not provide for display of an alternate field or some other place-holding indicia.

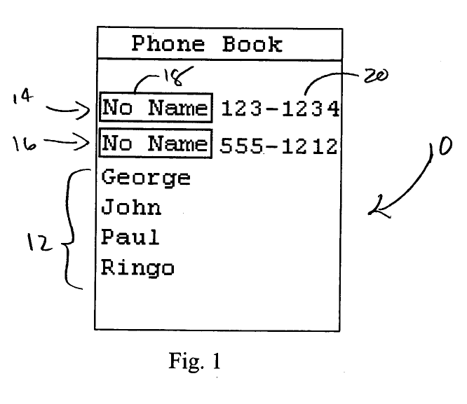

In FIG. 1, a list of phone book entries is presented, generally at 10, listed by given name, shown at 12, wherein the first two entries, 14 and 16, have no data entered in the “given name” data field, making the “given name” field a blank field. Using the method of the invention, a “No Name” field graphic 18, referred to herein as system generated fill data, is displayed in conjunction with the phone number 20, referred to herein as an alternate field, in lieu of displaying a blank display for this entry.

The method of the invention provides for two possible substitute entries when the display protocol encounters a blank data field: The system using the method of the invention may generate a system generated fill, in the form of a graphic or enhanced text; and/or the system may place an alternate field into the blank field as directed by the modified display protocol of the method of the invention. In the example of FIG. 1, a graphic and a phone number are displayed, which may be displayed in a manner color that is not available for display of the required field under the display protocol.

A graphic, the system generated fill, for a blank field may include, but is not limited to, images, font manipulations, e.g., bold, italics, underlining, reverse video, color change, different fonts, reserved characters or graphics mixed with text.

A graphics may be displayed in conjunction with an alternate field. In the example above, the phone number is an alternate field that is displayed when the given name is not available. In some instances, the method of the invention may only require that the alternate field be provided, without an additional graphic, and display the alternate field in a manner different than that used for a field which contains entered information.

Thus, a user interface for filling or setting null black spaces in a data base has been disclosed. It will be appreciated that further variations and modifications thereof may be made within the scope of the invention as defined in the appended claims.

1. A method of providing a user interface for use with a data base, wherein the database includes plural records, each having plural data fields therein, wherein a data field contains information taken from the group of information types consisting of entered information, empty and null, wherein empty and null data fields comprise blank data fields, comprising:
displaying a selected record according to a display protocol;
determining if the display protocol requires display of a blank data field of the record, and, if so, displaying a substitute data field which is taken from the group of data fields consisting of system generated data fields and alternate data fields;
wherein said displaying a substitute data field includes displaying the information in the substitute data field in a enhanced manner to alert a user to the presence of the substitute information.

2. The method of claim 1 wherein said displaying a substitute data field which is a system generated data field includes inserting an image into the data field, manipulations the font of the data field, including presenting the font in bold, italic, underlined, in reverse video, with a color change, changing the fonts, using reserved characters, and providing a graphic mixed with text.

3. The method of claim 1 wherein said displaying a substitute data field which is an alternate date field includes selecting a data field containing entered information and presenting the data field information to the user interface.

4. A method of providing a user interface for use with a data base, wherein the database includes plural records, each having plural data fields therein, wherein a data field contains information taken from the group of information types consisting of entered information, empty and null, wherein empty and null data fields comprise blank data fields, comprising:
displaying a selected record according to a display protocol;
determining if the display protocol requires display of a blank data field of the record, and, if so, displaying a substitute data field which is taken from the group of data fields consisting of system generated data fields, including includes inserting an image into the data field, manipulations the font of the data field, including presenting the font in bold, italic, underlined, in reverse video, with a color change, changing the fonts, using reserved characters, and providing a graphic mixed with text; and alternate data fields;
wherein said displaying a substitute data field includes displaying the information in the substitute data field in a enhanced manner to alert a user to the presence of the substitute information.

5. The method of claim 4 wherein said displaying a substitute data field which is an alternate data field includes selecting a data field containing entered information and presenting that data field information to the user interface.

6. A method of providing a user interface for use with a data base, wherein the database includes plural records, each having plural data fields therein, wherein a data field contains information taken from the group of information types consisting of entered information, empty and null, wherein empty and null data fields comprise blank data fields, comprising:
displaying a selected record according to a display protocol;
determining if the display protocol requires display of a blank data field of the record, and, if so, displaying a substitute data field which is taken from the group of data fields consisting of system generated data fields and alternate data fields, including selecting a data field containing entered information and presenting that data field information to the user interface;
wherein said displaying a substitute data field includes displaying the information in the substitute data field in a enhanced manner to alert a user to the presence of the substitute information.

7. The method of claim 6 wherein said displaying a substitute data field which is a system generated data field includes inserting an image into the data field, manipulations the font of the data field, including presenting the font in bold, italic, underlined, in reverse video, with a color change, changing the fonts, using reserved characters, and providing a graphic mixed with text.
